(19) United States
(12) Patent Application Publication
(10) Pub. No.: US 2007/0101866 A1
(43) Pub. Date: May 10, 2007

(54) Air dehumidifying treatment device for air compressors

(76) Inventor: Teng-Fu Chen, Taichung County (TW)

Correspondence Address: BIRCH STEWART KOLASCH & BIRCH, PO BOX 747, FALLS CHURCH, VA, 22040-0747, US

(21) Appl. No.: 11/269,683

(22) Filed: Nov. 9, 2005

(51) Int. Cl. B01D 19/00

(52) U.S. Cl. 96/188

(57) ABSTRACT

An air dehumidifying treatment device for air compressor includes a case having a board set received therein and the board set is in contact with an inner periphery of the case so as to define four compartments wherein air is introduced in the first compartment and then goes through the second and the fourth compartment via holes defined in the board set and then goes out from the fourth compartment. The holes are located at different heights and drain-pipes are in communication with the first and the third compartments so as to lower the humidity in the air.

### FIELD OF THE INVENTION

The present invention relates to an air dehumidifying treatment device for air compressor and the device includes several compartments communicating with each other so as to reduce humidity in the air.

### BACKGROUND OF THE INVENTION

Some tools are powered by air which is compressed by a compressor and the pressurized air is introduced into hose connected to the tool so as to drive the tools. Generally, the air has a certain degree of humidity which might cause rust to the parts and/or short the circuit of the tools. In order to provide a good quality of the pressurized air, some compressors are cooperated with air dehumidifying treatment devices which cool the air and remove moisture from the air before being introduced into the tools. The conventional air dehumidifying treatment devices include a condenser and a filtering unit, both of which make the conventional air dehumidifying treatment device to be bulky and expensive.

The present invention intends to provide an air dehumidifying treatment device for an air compressor wherein the device includes at least two boards to define four compartments which are in communication with each other, and the air enters the compartment one by one to lower the humidity thereof.

### SUMMARY OF THE INVENTION

The present invention relates to an air dehumidifying treatment device which comprises a case having a cruciform board set received therein and the board set is in contact with an inner periphery of the case so as to define a first compartment, a second compartment, a third compartment and a fourth compartment. The first compartment communicates with the second compartment from a lower position, the second compartment communicates with the third compartment from a higher position, the third compartment communicates with the fourth compartment from a lower position. Air is introduced into the first compartment and goes through the communication holes at different heights to reduce the humidity, and the air is then sucked out from eh fourth compartment.

The primary object of the present invention is to provide an air dehumidifying treatment device for air compressors, the air goes through compartments up and down to lower the humidity thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a perspective view of the air dehumidifying treatment device of the present invention;

FIG. 2 is an exploded view to show the board set in the air dehumidifying treatment device of the present invention;

FIG. 3 shows that air goes through compartments via holes in the board set;

FIG. 4 is a cross sectional view to show the holes in the board set;

FIG. 5 shows a perspective view of another embodiment of the air dehumidifying treatment device of the present invention, and FIG. 6 is an exploded view to show the board set in the air dehumidifying treatment device in FIG. 5 of the present invention.

### DETAILED DESCRIPTION OF THE PREFERRED EMBODIMENT

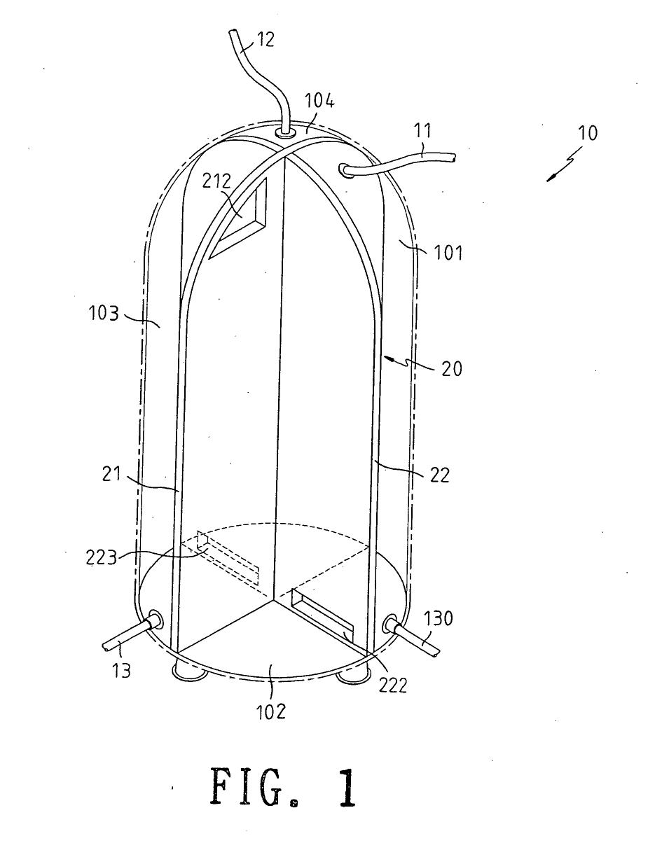

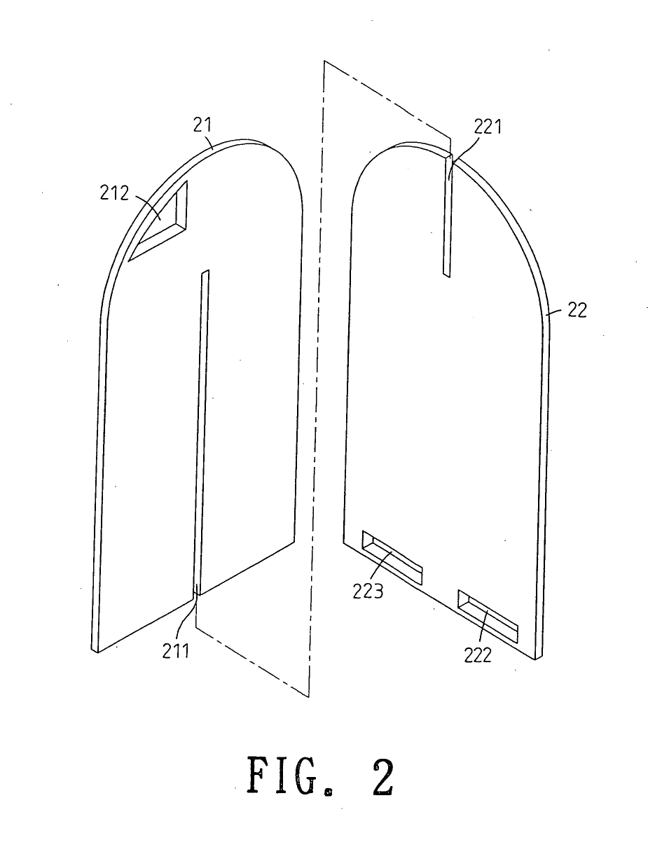

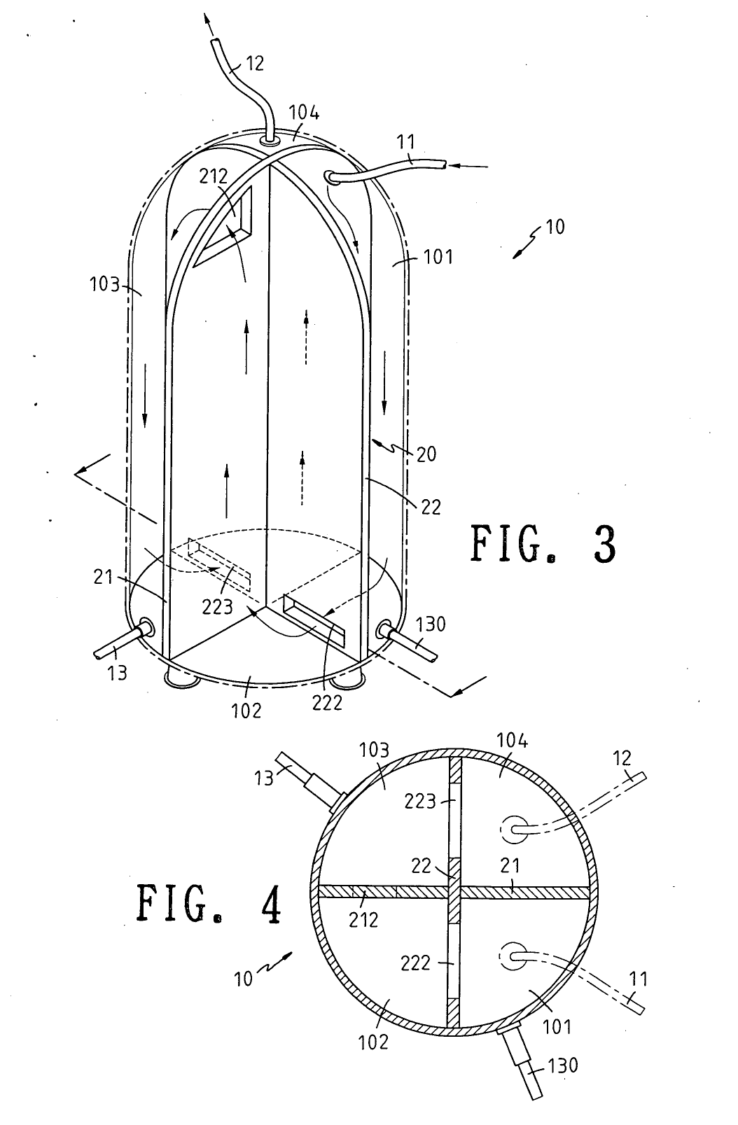

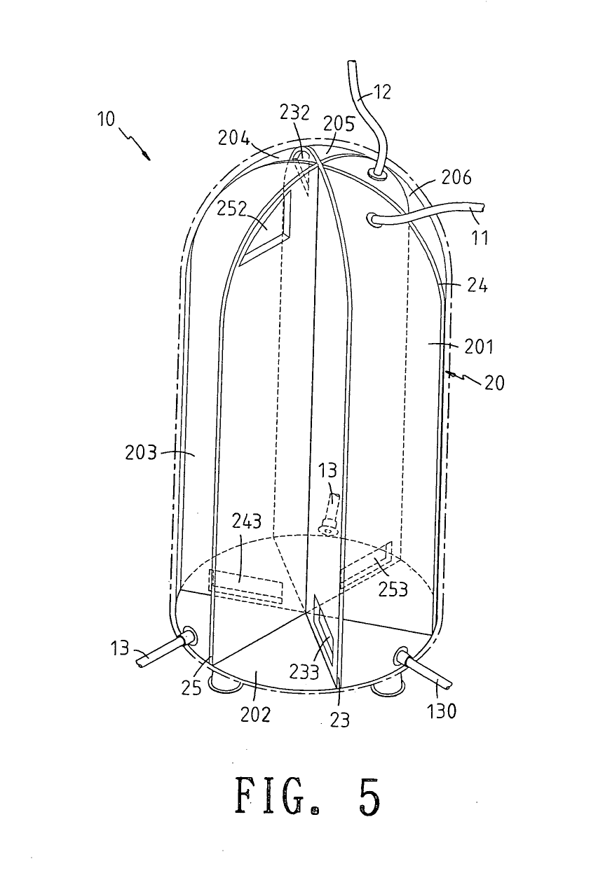

Referring to FIGS. 1 to 4, the air dehumidifying treatment device 10 for air compressors of the present invention comprises an enclosed case having a board set 20 received therein and the board set 20 is in contact with an inner periphery of the case. The board set 20 includes a first board 21 and a second board 22, wherein the first board 21 and the second board 22 are perpendicular to each other so as to define a first compartment 101, a second compartment 102, a third compartment 103 and a fourth compartment 104.

The first board 21 has a first slot 211 defined centrally from an underside thereof and the second board 22 has a second slot 221 defined centrally from a top thereof. The top of the second board 22 is inserted into the first slot 211 of the first board 21 and a top of the first board 21 is engaged with the second slot 221. The first board 21 has a first hole 212 defined therethrough and located close to left of the top of the first board 21. The second board 22 has a second hole 222 and a third hole 223 is defined therethrough and located close to an underside of the second board 22. The first and second compartments 101, 102 are in communication with each other via the second hole 222. The second and third compartments 102, 103 are in communication with each other via the first hole 222. The third and fourth compartments 103, 104 are in communication with each other via the third hole 223.

An inlet pipe 11 is in communicating with the first compartment 101 from a top of the case and an outlet pipe 12 is in communicating with the fourth compartment 104 from the top of the case. A first drain-pipe 13 and a second drain-pipe 130 are in communication with the third compartment 103 and the first compartment 101 via two respective lower portions of the case.

Air is introduced into the first compartment 101 via the inlet pipe 11 and goes up and down through the second compartment 102, the third compartment 103 and the fourth compartment 104 via the second hole 222, the first hole 212 and the third hole 223. The humidity of the air is lowered and the condensed water left in the case drains out from the two drain-pipes 13, 130. The air is then sucked via the outlet pipe 12 and provided to the tools which are not shown.

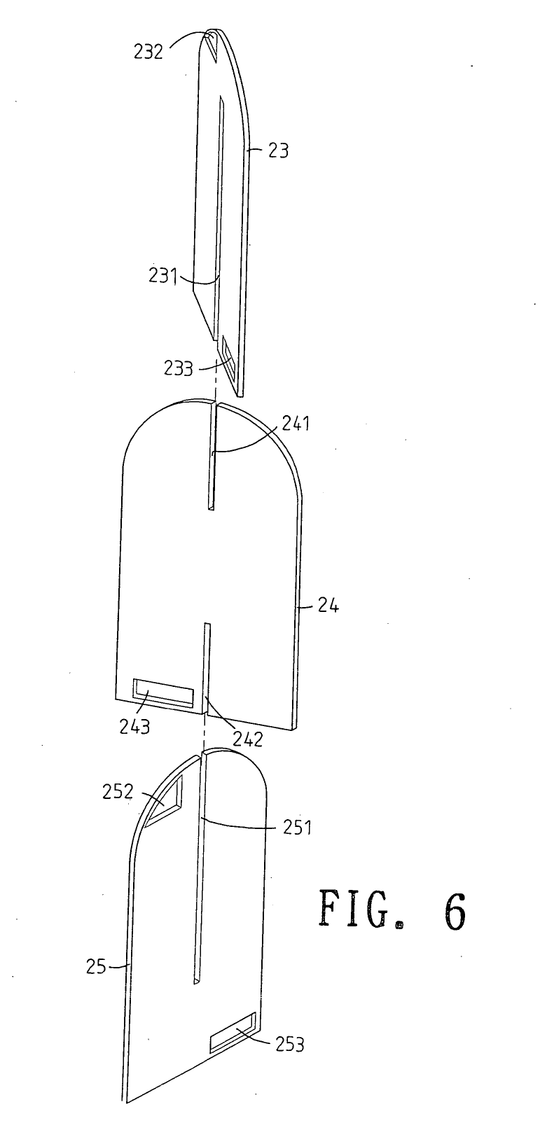

Referring to FIGS. 5 and 6, another embodiment of the air dehumidifying treatment device 10 comprises a case having a board set 20 received therein and the board set 20 is in contact with an inner periphery of the case. The board set 20 includes a first board 23, a second board 24 and a third board 25. The first board 21 has a first slot 231 defined centrally from an underside thereof and the second board 24 has a second slot 241 defined centrally from a top thereof and a third slot 242 defined centrally from an underside thereof. The third board 25 has a fourth slot 251 defined from a top thereof. The second board 24 is inserted into the fourth slot 251 of the third board 25 and a lower portion of the third board 25 is engaged with the third slot 242 of the second board 24. The top of the second board 24 is inserted into the first slot 231 of the first board 23 and a top portion of the first board 23 is engaged with the second slot 241 of the second board 24. By the arrangement, the board set 20 defines a first compartment 201, a second compartment 202, a third compartment 203, a fourth compartment 204, a fifth compartment 205, and a sixth compartment 206. A clamp angle of 60 degrees is defined between the first board 23, the second board 24 and the third board 25.

The first board 23 has a first hole 232 defined therethrough and located close to left of the top of the first board 21. The first board 23 has a second hole 233 defined therethrough and located close to right of the underside of the first board 21. The second board 24 has a third hole 243 defined therethrough and located close to left of the underside thereof. The third board 25 has a fourth hole 252 defined therethrough and located to left of the top thereof. The third board 25 has a fifth hole 253 defined therethrough and located to right of an underside thereof. The first and second compartments 201, 202 are in communication with each other via the second hole 233. The second and third compartments 202, 203 are in communication with each other via the fourth hole 252. The third and fourth compartments 203, 204 are in communication with each other via the third hole 243. The fourth and fifth compartments 204, 205 are in communication with each other via the first hole 232. The fifth and sixth compartments 205, 206 are in communication with each other via the fifth hole 253.

An inlet pipe 11 is in communicating with the first compartment 201 from a top of the case and an outlet pipe 12 is in communicating with the sixth compartment 206 from the top of the case. A first drain-pipe 13 is in communication with the third compartment 203 via a lower portion of the case and a second drain-pipe 130 is in communication with the first compartment 201 via the lower portion of the case.

While we have shown and described the embodiment in accordance with the present invention, it should be clear to those skilled in the art that further embodiments may be made without departing from the scope of the present invention.

What is claimed is:

1. An air dehumidifying treatment device comprising:
a case having a board set received therein and the board set being in contact with an inner periphery of the case so as to define a first compartment, a second compartment, a third compartment and a fourth compartment, the first compartment communicating with the second compartment from a lower position, the second compartment communicating with the third compartment from a higher position, the third compartment communicating with the fourth compartment from a lower position, and
an inlet pipe being in communicating with the first compartment from a top of the case and an outlet pipe being in communicating with the fourth compartment from the top of the case, a first drain-pipe being in communication with the third compartment via a lower portion of the case.

2. The device as claimed in claim 1, wherein the board set includes a first board and a second board, the first board has a first slot defined centrally from an underside thereof and the second board has a second slot defined centrally from a top thereof, the top of the second board is inserted into the first slot of the first board and a top of the first board is engaged with the second slot, the first board has a first hole defined therethrough and located close to left of the top of the first board, the second board has a second hole and a third hole is defined therethrough and located close to an underside of the second board, the first and second compartments are in communication with each other via the second hole, the second and third compartments are in communication with each other via the first hole, the third and fourth compartments are in communication with each other via the third hole.

3. The device as claimed in claim 1, wherein a second drain-pipe is in communication with the first compartment via the lower portion of the case.

4. The device as claimed in claim 2, wherein the first board and the second board are perpendicular to each other.

5. An air dehumidifying treatment device comprising:
a case having a board set received therein and the board set being in contact with an inner periphery of the case so as to define a first compartment, a second compartment, a third compartment, a fourth compartment, a fifth compartment, and a sixth compartment, the first compartment communicating with the second compartment from a lower position, the second compartment communicating with the third compartment from a higher position, the third compartment communicating with the fourth compartment from a lower position, the fourth compartment communicating with the fifth compartment from a higher position, the fifth compartment communicating with the sixth compartment from a lower position, and
an inlet pipe being in communicating with the first compartment from a top of the case and an outlet pipe being in communicating with the sixth compartment from the top of the case, a first drain-pipe being in communication with the third compartment via a lower portion of the case.

6. The device as claimed in claim 5, wherein the board set includes a first board, a second board and a third board, the first board has a first slot defined centrally from an underside thereof and the second board has a second slot defined centrally from a top thereof and a third-slot defined centrally from an underside thereof, the third board has a fourth slot defined from a top thereof, the second board is inserted into the fourth slot of the third board and a lower portion of the third board is engaged with the third slot of the second board, the top of the second board is inserted into the first slot of the first board and a top portion of the first board is engaged with the second slot of the second board, the first board has a first hole defined therethrough and located close to left of the top of the first board, the first board has a second hole defined therethrough and located close to right of the underside of the first board, the second board has a third hole defined therethrough and located close to left of the underside thereof, the third board has a fourth hole defined therethrough and located to left of the top thereof, the third board has a fifth hole defined therethrough and located to right of an underside thereof, the first and second compartments are in communication with each other via the second hole, the second and third compartments are in communication with each other via the fourth hole, the third and fourth compartments are in communication with each other via the third hole, the fourth and fifth compartments are in communication with each other via the first hole, the fifth and sixth compartments are in communication with each other via the fifth hole.

7. The device as claimed in claim 5, wherein a second drain-pipe is in communication with the first compartment via the lower portion of the case.

8. The device as claimed in claim 6, wherein a clamp angle of 60 degrees is defined between the first board, the second board and the third board.
